(19) United States
(12) Patent Application Publication
(10) Pub. No.: US 2024/0186637 A1
(43) Pub. Date: Jun. 6, 2024

(54) BATTERY PACK

(71) Applicant: MILWAUKEE ELECTRIC TOOL CORPORATION, Brookfield, WI (US)

(72) Inventors: Wyatt R. Silha, Milwaukee, WI (US); Carmen J. Castaños, Milwaukee, WI (US); Eli M. Zidel, Milwaukee, WI (US); Zachery Meyer, Hartland, WI (US); John L. Whealon, West Bend, WI (US); Jonathan Quenzer, German Valley, IL (US)

(21) Appl. No.: 18/521,233

(22) Filed: Nov. 28, 2023

Related U.S. Application Data
(60) Provisional application No. 63/430,590, filed on Dec. 6, 2022.

(51) Int. Cl. H01M 50/262; H01M 10/42; H01M 50/244; H01M 50/247; H01M 50/284

(52) U.S. Cl. CPC H01M 50/262; H01M 10/425; H01M 50/244; H01M 50/247; H01M 50/284; H01M 2220/30

(57) ABSTRACT

A battery pack includes a housing, a flexible button, and a switch. The housing includes an opening and a groove. The groove is disposed at least partially about the opening. The flexible button is molded onto the housing in the opening. The flexible button includes a user engagement portion, a sidewall, a lip, and a post. The sidewall extends from the user engagement portion into the housing. The lip extends laterally from the sidewall. The lip includes a ridge protruding into the groove of the housing. The post extends from the user engagement portion. The switch is disposed in the housing. The switch is positioned to be engaged by the post.

### CROSS-REFERENCE TO RELATED APPLICATIONS

The present application claims priority to U.S. provisional application No. 63/430,590, filed Dec. 6, 2022, the entire contents of which are incorporated by reference herein.

### FIELD

The present disclosure relates to battery packs, and more particularly to battery packs configured to interface with power tools.

### BACKGROUND

Many manufacturing processes are slowed due to complex assemblies (e.g., buttons in housings) due to steps required to assemble, fasten, and test multiple pieces together. Therefore, it is beneficial for the housing of battery packs to be formed such that it is easy to mold or assemble periphery components to the housing.

### SUMMARY

The disclosure provides, in one aspect, a battery pack with a housing, a flexible button, and a switch. The housing includes an opening and a groove. The groove is disposed at least partially about the opening. The flexible button is molded onto the housing in the opening. The flexible button includes a user engagement portion, a sidewall, a lip, and a post. The sidewall extends from the user engagement portion into the housing. The lip extends laterally from the sidewall. The lip includes a ridge protruding into the groove of the housing. The post extends from the user engagement portion. The switch is disposed in the housing. The switch is positioned to be engaged by the post.

In another independent aspect, the disclosure provides a battery pack with a housing, a light pipe, a retention member, and a light-emitting diode (LED). The housing defines a passage therein. The light pipe is disposed in the passage. The light pipe includes a base and an emission surface. The emission surface is opposite the base. The retention member is coupled to the housing. The retention member includes a protrusion extending over at least a portion of the base to retain the light pipe in the passage. The LED is disposed in the housing. The LED is positioned to emit light into the base of the light pipe. The light exits the light pipe through the emission surface.

In another independent aspect, the disclosure provides a battery pack with a housing, a light pipe, a retention member, a light-emitting diode (LED), a flexible button, and a switch. The housing defines a passage therein. The light pipe is supported within the passage. The light pipe includes a base and an emission surface. The emission surface is opposite the base. The retention member is coupled to the housing. The retention member includes a protrusion extending over at least a portion of the base to retain the light pipe in the passage. The LED is positioned to emit light into the base of the light pipe. The light exits the light pipe through the emission surface. The flexible button is molded onto the housing in the opening. The flexible button includes a user engagement portion, a sidewall, a lip, and a post. The sidewall extends from the user engagement portion into the housing. The lip extends laterally from the sidewall. The lip includes a ridge protruding into the groove of the housing. The post extends from the user engagement portion. The switch is disposed in the housing. The switch is positioned to be engaged by the post.

### BRIEF DESCRIPTION OF THE DRAWINGS

FIG. 1 is a perspective view of a battery pack, according to embodiments disclosed herein.

FIG. 2 is a detailed side cross-sectional elevation view of the battery pack in FIG. 1.

FIG. 3 is a detailed side cross-sectional view of the housing of the battery pack of FIG. 1 with the button removed.

FIG. 4 is a detailed perspective cross-sectional view of the housing of the battery pack of FIG. 1 with the button included.

FIG. 5 is a perspective view of a plurality of light pipes of the battery pack of FIG. 1.

FIG. 6 is a bottom perspective view of a portion of the battery pack of FIG. 1 illustrating a retention member in the housing.

### DETAILED DESCRIPTION

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting.

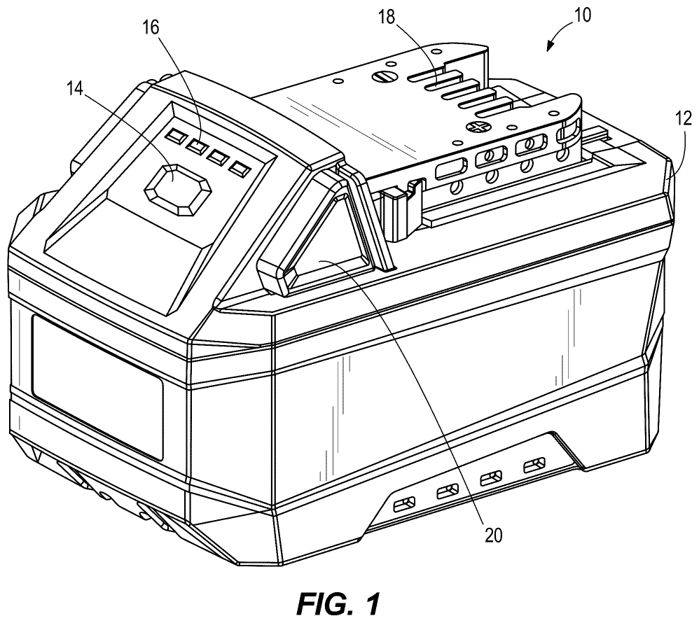

With reference to FIG. 1, an embodiment of a battery pack 10 is shown. The battery pack 10 is configured to power a variety of power tools and to be charged by a charger. The battery pack 10 includes a housing 12, a flexible button 14, a plurality of light pipes 16, a plurality of terminals 18, and a release mechanism 20. The battery pack 10 can also power any other electronic device configured to interface with the battery pack 10 through the terminals 18. In the current embodiment, the release mechanism 20 includes two instances of a button and a connected hook to releasably couple the battery pack to an appropriate device.

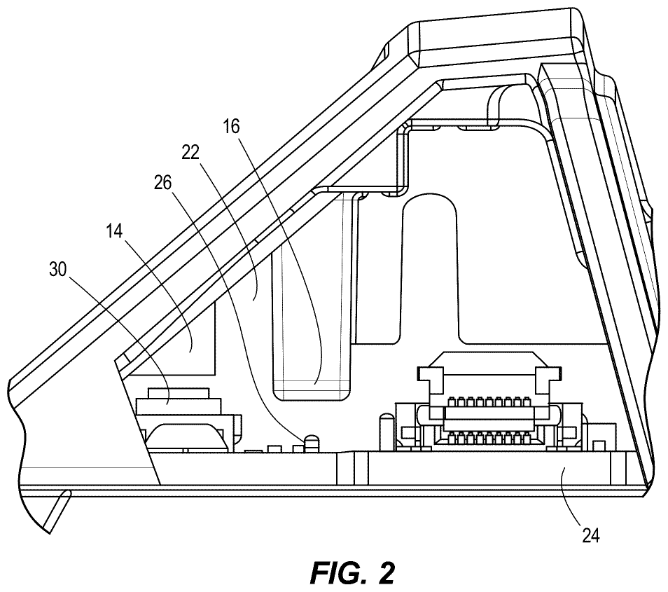

With reference to FIG. 2, the housing 12 has an inner cavity 22, wherein a circuit board 24 is disposed. The circuit board 24 contains at least one light-emitting diode (LED) 26 configured to illuminate the light pipes 16 in response to a control signal from a microcontroller. A switch 30 is positioned on the circuit board 24 to be engaged by the flexible button 14.

With specific reference to FIG. 3, the housing 12 has a passage 32 and an opening 34 defining at least one groove 36 therein. The passage 32 extends into the cavity 22. In some embodiments, the passage 32 also extends to the outer surface of the housing 12. The opening 34 and groove 36 define a peripheral wall 38 that extends into the cavity 22 around the opening 34. The groove 36 surrounds the perimeter of the opening 34. In other embodiments, the groove 36 may partially surround the perimeter of the opening 34.

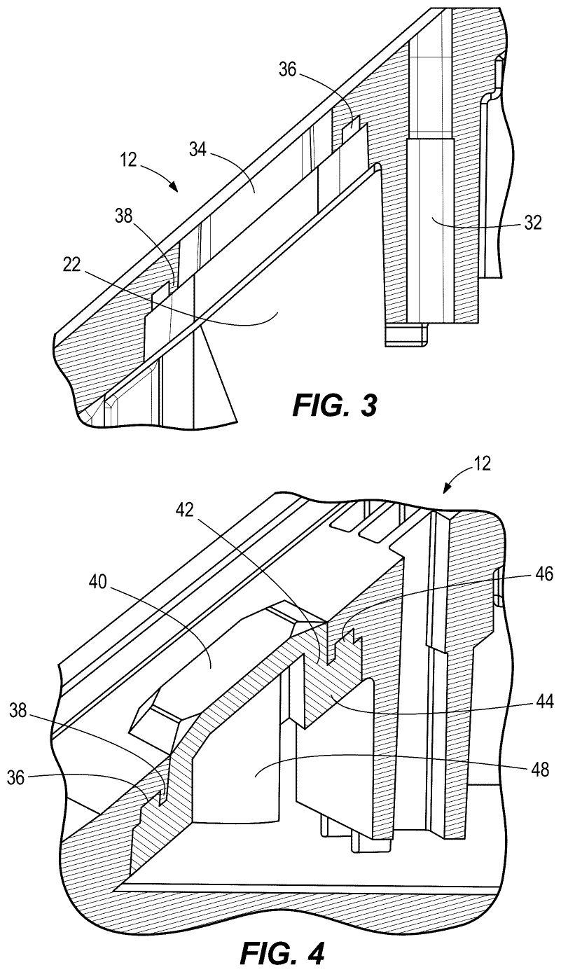

With reference to FIG. 4, the button 14 is molded into the opening 34 and groove 36 defined within the housing 12. The button includes a user engagement portion 40, a sidewall 42, a lip 44, and a ridge 46. In some embodiments, the button 14 is molded as a unitary piece and is configured to move toward the cavity 22 when the user engagement portion 40 is pressed. A sidewall 42 extends from the user engagement portion 40 along the peripheral wall 38 into the cavity 22. Holding the button 14 onto the housing 12, a lip 44 extends radially outward from the sidewall 42, further defining at least one ridge 46 that extends into the groove 36. Additionally, a post 48 extends from the user engagement portion 40 toward the cavity 22. In this embodiment, the post 48 engages the switch 30 when the user engagement portion 40 is depressed.

In some embodiments, depressing the user engagement portion 40 deforms the user engagement portion 40 and allows the sidewall 42 to bend away from the peripheral wall 38 of the housing 12. In other embodiments, the sidewall 42 shifts along the surface of the peripheral wall 38 toward the cavity 22. In yet another embodiment, the sidewall 42 remains fixed against the peripheral wall 38.

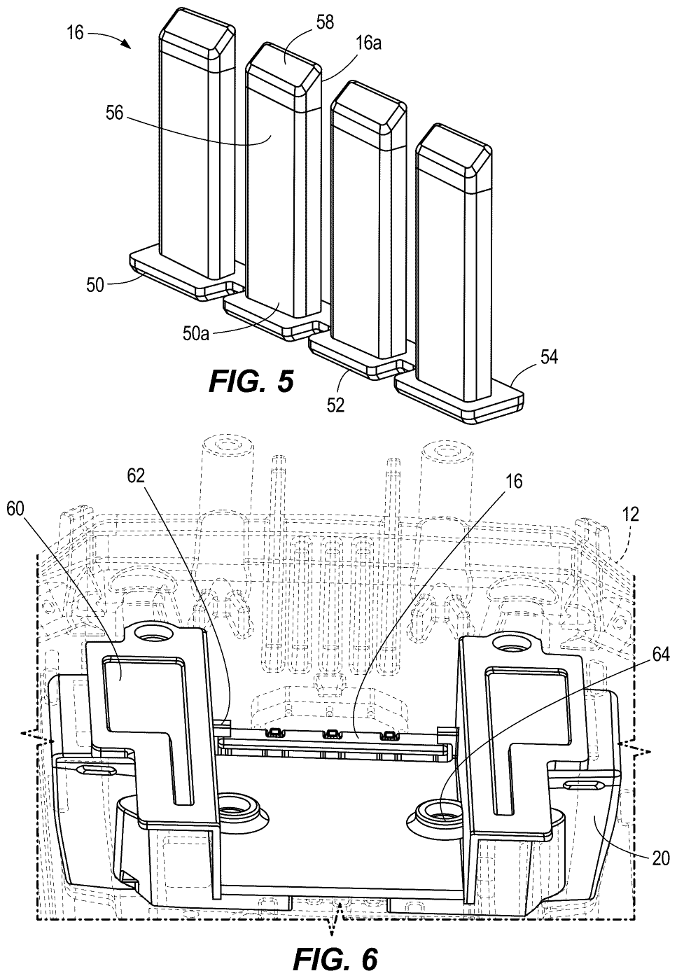

With reference to FIG. 5, the current embodiment includes a plurality of connected light pipes 16, wherein each light pipe 16a serves a similar purpose and are parallel to one another. In other embodiments, only a single light pipe 16a is present. The light pipes 16 have a base 50 that includes a protrusion 52 extending radially outward from each respective light pipe 16a. Additionally, the base 50 includes a rail 54 extending along the protrusions 52 of each light pipe 16a. The rail 54 is used to combine each light pipe 16a into a single interconnected piece along the base 50. The base 50 serves as the light-receiving end of the light pipe 16a, with each light pipe 16a having a respective light receiving base 50a. In the current embodiment, the light receiving base 50a is rectangular and ends on a flat end. In other embodiments, the light receiving base 50a is conical and can be positioned to encase the body of the LED 26.

Opposite the base 50, each light pipe 16a includes an emission surface 58. A light pipe body 56 extends between the base 50 and the emission surface 58 for each light pipe 16a. The emission surface 58 serves as the user-facing end of the light pipe 16a. In the current embodiment, the emission surface 58 is angled relative to the base and is textured to facilitate diffusion of the light traveling through the light pipe body 56 and exiting the emission surface 58. The texture on the emission surface 58 may include dimples, grooves, dents, scratches, or the like. In some embodiments, the emission surface 58 may be a different material than that of the base 50, rail 54, or body 56. Still other embodiments may include voids, impurities, or the like disposed within the light pipe body 56 nearer to the emission surface 58 than to the base 50. Still other embodiments could use, for instance, a film.

With reference to FIG. 6, a retention member 60 is disposed within the cavity 22 of the housing 12. The retention member 60 is configured to hold the light pipes 16 within the housing 12 using a plurality of L-shaped hook-like protrusions 62 engaging the protrusions 52 of the base 50. In some embodiments, the protrusions 62 may have a different shape, or not be protrusions at all. For instance, some embodiments could include a bar, lump, ledge, or the like. In addition to supporting the light pipes, the retention member 60 supports the release mechanism 20 within the housing 12. The retention member 60 is removably fastened to the housing 12 using at least one fastener extending through a corresponding fastening hole 64.

We claim:

1. A battery pack comprising:
a housing including an opening and a groove disposed at least partially about the opening;
a flexible button molded onto the housing in the opening, the flexible button including
a user engagement portion,
a sidewall extending from the user engagement portion into the housing,
a lip extending laterally from the sidewall, the lip including a ridge protruding into the groove of the housing, and
a post extending from the user engagement portion; and
a switch disposed in the housing, the switch positioned to be engaged by the post.

2. The battery pack of claim 1, wherein the flexible button is molded as a unitary piece.

3. The battery pack of claim 1, wherein the post extends parallel to the sidewall.

4. The battery pack of claim 1, wherein the user engagement portion is chamfered and raised from the opening.

5. The battery pack of claim 1, wherein the lip forms a continuous perimeter about the post.

6. The battery pack of claim 1, wherein the ridge protrudes in a direction parallel to the sidewall.

7. A battery pack comprising:
a housing defining a passage therein;
a light pipe disposed in the passage, the light pipe including
a base, and
an emission surface opposite the base;
a retention member coupled to the housing, the retention member including a protrusion extending over at least a portion of the base to retain the light pipe in the passage; and
a light-emitting diode (LED) disposed in the housing, the LED positioned to emit light into the base of the light pipe, the light exiting the light pipe through the emission surface.

8. The battery pack of claim 7, wherein the retention member is removably coupled to the housing by a plurality of fasteners.

9. The battery pack of claim 7, wherein the emission surface of the light pipe is textured.

10. The battery pack of claim 7, wherein the emission surface is angled relative to the base.

11. The battery pack of claim 7, wherein the base of the light pipe includes a flange.

12. The battery pack of claim 11, wherein the protrusion contacts the flange of the base.

13. The battery pack of claim 7, wherein the protrusion includes a hook.

14. The battery pack of claim 7, wherein the protrusion is L-shaped.

15. The battery pack of claim 7, wherein the passage is one of a plurality of passages defined in the housing, and the light pipe is one of a plurality of light pipes, each light pipe disposed in a respective passage.

16. The battery pack of claim 15, wherein the light pipes extend parallel to each other.

17. The battery pack of claim 7, further comprising:
a release button actuatable to release the battery pack from a power tool, and
wherein the retention member retains the release button in the housing.

18. The battery pack of claim 17, wherein the release button is one of two release buttons, and the light pipe is disposed between the two release buttons.

19. A battery pack comprising:
a housing defining a passage therein;
a light pipe supported within the passage, the light pipe including
a base, and
an emission surface opposite the base;
a retention member coupled to the housing, the retention member including a protrusion extending over at least a portion of the base to retain the light pipe in the passage; and
a light emitting diode (LED) positioned to emit light into the base of the light pipe, the light exiting the light pipe through the emission surface;
a flexible button molded onto the housing in the opening, the flexible button including
a user engagement portion,
a sidewall extending from the user engagement portion into the housing,
a lip extending laterally from the sidewall, the lip including a ridge protruding into the groove of the housing, and
a post extending from the user engagement portion; and
a switch disposed in the housing, the switch positioned to be engaged by the post.

20. The battery pack of claim 19, wherein the LED and switch are disposed on a circuit board.
